(19) United States
(12) Patent Application Publication
(10) Pub. No.: US 2019/0283486 A1
(43) Pub. Date: Sep. 19, 2019

(54) ROD-LIKE OBJECT DISPENSING CONTAINER

(71) Applicant: KOTOBUKI & CO., LTD., Kawagoe-shi (JP)

(72) Inventor: Tadao ODAKA, Kawagoe-shi (JP)

(21) Appl. No.: 16/431,423

(22) Filed: Jun. 4, 2019

Related U.S. Application Data
(63) Continuation of application No. PCT/JP2017/044457, filed on Dec. 12, 2017.

(30) Foreign Application Priority Data
Dec. 12, 2016 (JP) 2016-239971

(51) Int. Cl. B43K 29/02; A45D 40/20; A45D 40/06; B43L 19/00

(52) U.S. Cl. CPC B43K 29/02; B43L 19/0081; A45D 40/06; A45D 40/20

(57) ABSTRACT

A rod-like object dispensing container according to an embodiment includes a helical cylinder, an inner cylinder and a rod-like object holder, wherein the rod-like object holder includes a bottom plate having a receiving part receiving a rod-like object, sliding piece parts having a rod-like object supporting part that slidably engages with the inner cylinder, and protruding parts protruding outward in a radial direction from the sliding piece parts respectively that slidably engages with the helical cylinder, and a thin wall part extending in a direction intersecting the radial direction is formed in each supporting base part for the sliding piece parts of the bottom plate supporting the sliding piece parts.

### CROSS-REFERENCE TO RELATED APPLICATION

This application is based upon and claims the benefit of priority (JP2016-239971, Dec. 12, 2016) under 35 USC 119 of PCT Application No. PCT/JP2017/44457 filed on Dec. 12, 2017, the entire disclosure of which, including the description, claims, drawings, and abstract, is incorporated herein by reference in its entirety.

### BACKGROUND

### 1. Technical Field

This disclosure relates to a rod-like object dispensing container capable of dispensing a rod-like object by a rotating operation.

### 2. Related Art

Conventionally, rod-like object dispensing containers which dispense a rod-like object by a rotating operation are known. A rod-like object dispensing container disclosed in WO 2008/146554 includes a helical cylinder which has a helical groove, an inner cylinder which has slits, and a rod-like object holder which has a protruding part that engages with the helical groove of the helical cylinder and sliding piece parts that are guided in an axial direction by the slit of the inner cylinder (for example, refer to paragraph [0043] and FIG. 8). With the rod-like object dispensing container, a dispensing operation that involves relatively rotating the helical cylinder with respect to the inner cylinder enables the rod-like object holder to move in the axial direction and enables a rod-like object to protrude and recede.

A front flange is formed in a front end part (an opening part) of the inner cylinder of the rod-like object dispensing container disclosed in WO 2008/146554, and front ends of the slits are closed by the front flange. A receiving part for receiving a rear part of a rod-like object is formed in the rod-like object holder, and the sliding piece parts are formed on a side of an outer diameter direction relative to the receiving part so as to extend in an axial direction and abut with an outer surface of the rod-like object. An incision extending in a radial direction is formed on the receiving part so that the sliding piece parts tilt when assembling the rod-like object holder to the inner cylinder. Since the incision enables the sliding piece parts to tilt in an inner diameter direction, the sliding piece parts can be passed under the front flange of the inner cylinder and the rod-like object holder can be assembled into the inner cylinder.

When assembling the rod-like object holder to the conventional rod-like object dispensing container, all of the sliding piece parts of the rod-like object holder are required to be pressed toward a central axis of the rod-like object holder so that all of the sliding piece parts uniformly tilt and elastically deform by at least a prescribed amount or more. For example, when a pressing direction deviates from a direction toward the central axis of the rod-like object holder or a pressing force differs for each sliding piece part, it may be difficult to assemble the rod-like object holder to the inner cylinder in any modes with a tilting direction of the sliding piece parts deviating from an opening direction of the slits of the inner cylinder, or the protruding parts of the sliding piece parts being unable to pass under the front flange, or the like.

Conventionally, a rod-like object dispensing container that is more readily assembled than conventional rod-like object dispensing containers has been desired.

### SUMMARY

In an aspect of the present invention, the rod-like object dispensing container includes a helical cylinder configured to have a helical groove on a cylindrical inner circumferential surface; an inner cylinder configured to be formed in a cylindrical shape and arranged inside the helical cylinder, and configured to have a plurality of slits extending in an axial direction, and configured to be relatively rotatable with respect to the helical cylinder around an axis and configured so that movement in the axial direction is restricted; and a rod-like object holder configured to hold a rod-like object, and configured to be relatively movable in the axial direction with respect to the inner cylinder, wherein the rod-like object holder includes a bottom plate configured to have a receiving part receiving an end surface of the rod-like object, a plurality of sliding piece parts configured to have a rod-like object supporting part extending in the axial direction and supporting an outer surface of the rod-like object, and configured to slidably engage with the slits of the inner cylinder, and a plurality of protruding parts configured to protrude outward in a radial direction from the sliding piece parts respectively and configured to slidably engage with the helical groove of the helical cylinder, and a thin wall part configured to extend in a direction intersecting the radial direction is formed in each supporting base part for the sliding piece parts of the bottom plate supporting the sliding piece parts.

According to an aspect of the present invention, a rod-like object dispensing container that is more readily assembled than conventional rod-like object dispensing containers can be provided.

### BRIEF DESCRIPTION OF THE DRAWINGS

FIG. 1 is a perspective view illustrating, from diagonally rearward, a mechanical pencil according to an embodiment of the present invention including a rod-like object dispensing container in a state where an eraser as the rod-like object is retracted;

FIG. 2 is a perspective view illustrating, from diagonally rearward, a mechanical pencil according to an embodiment of the present invention including a rod-like object dispensing container in a state where an eraser as the rod-like object is dispensed;

FIG. 3 is a sectional view illustrating a mechanical pencil according to an embodiment of the present invention including a rod-like object dispensing container, illustrated along a cutting plane having an arrow III-III illustrated in FIG. 1 as a normal, and illustrating a portion including the rod-like object dispensing container as viewed from a direction of the arrow III-III;

FIG. 4 is a sectional view illustrating, from the rear, a rod-like object dispensing container according to an embodiment of the present invention, illustrated along a cutting plane IV-IV illustrated in FIG. 3;

FIG. 5 is an exploded perspective view illustrating, from diagonally forward, a rod-like object dispensing container according to an embodiment of the present invention;

FIG. 6 is an exploded perspective view illustrating, from diagonally rearward, a rod-like object dispensing container according to an embodiment of the present invention;

FIG. 7 is a partial sectional side view illustrating a partially cut section of a rod-like object holder of a rod-like object dispensing container according to an embodiment of the present invention; and

FIG. 8 is an enlarged sectional view illustrating an enlargement of an opening end part of a rod-like object dispensing container in the sectional view illustrated in FIG. 3 of a mechanical pencil including a rod-like object dispensing container according to an embodiment of the present invention, and is a diagram illustrating a rod-like object dispensed to the maximum.

### EMBODIMENT

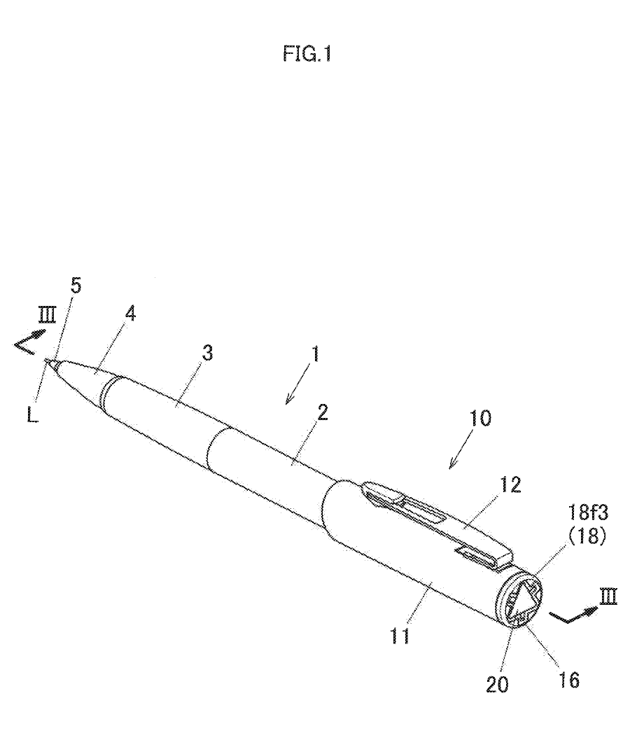

Hereinafter, an embodiment of the present invention will be described with reference to the drawings. A mechanical pencil 1 according to an embodiment of the present invention illustrated in FIG. 1 includes a rod-like object dispensing container 10. The mechanical pencil 1 includes a grip 3 and a tip fitting 4 on a tip side of a front barrel 2. Since a chuck and a feed-out mechanism of a writing lead for a mechanical pencil L of the mechanical pencil 1 are well-known mechanisms, a detailed description thereof will be omitted. Moreover, in the following description, a side of the tip fitting 4 will be referred to as front and an opposite side thereof will be referred to as rear along a central axis (an axial direction) of the mechanical pencil 1. In the mechanical pencil 1, a slider 5 protrudes from the tip of the tip fitting 4 by pushing a rear end of the rod-like object dispensing container 10, and the mechanical pencil 1 is used for writing in a state where a writing lead for a mechanical pencil L protrudes from the tip of the slider 5.

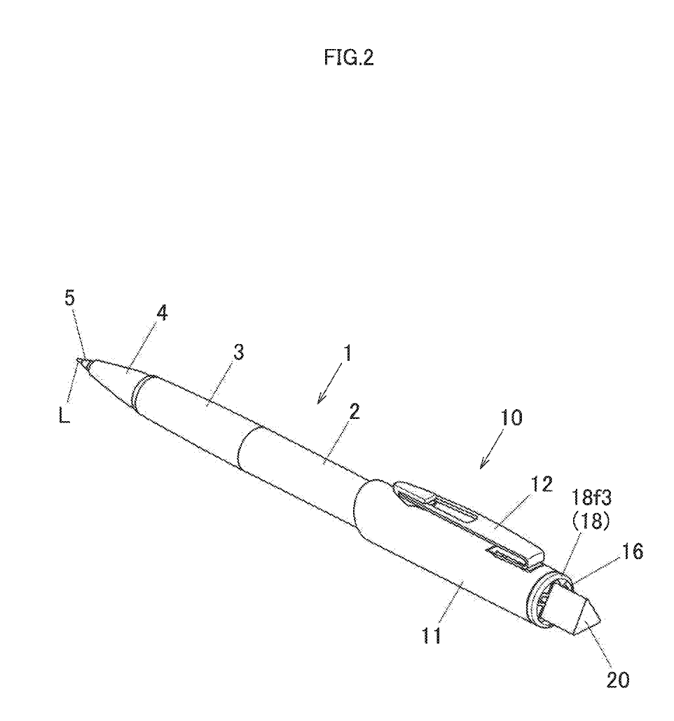

While a rod-like object 20 housed by the rod-like object dispensing container 10 according to the present embodiment is an eraser formed so as to have a triangular transverse section, in another embodiment, an eraser formed so as to have a circular transverse section may be used. In addition, while the eraser according to the present embodiment is a plastic eraser, in another embodiment, a rubber eraser may be used as the eraser. In yet another embodiment, an arbitrary rod-like object such as chalk formed in a rod shape can be used as the rod-like object 20. The rod-like object 20 is housed in an inner cylinder 18 assembled into a helical cylinder 11 that is an approximately cylindrical shaped outer cylinder including a clip 12. During use, as illustrated in FIG. 2, the rod-like object 20 can be dispensed so as to protrude from a rear end opening part of the rod-like object dispensing container 10. The rod-like object 20 is dispensed by relatively rotating the front barrel 2 and the helical cylinder 11. In the present embodiment, the helical cylinder 11 constitutes a rear barrel of the mechanical pencil 1.

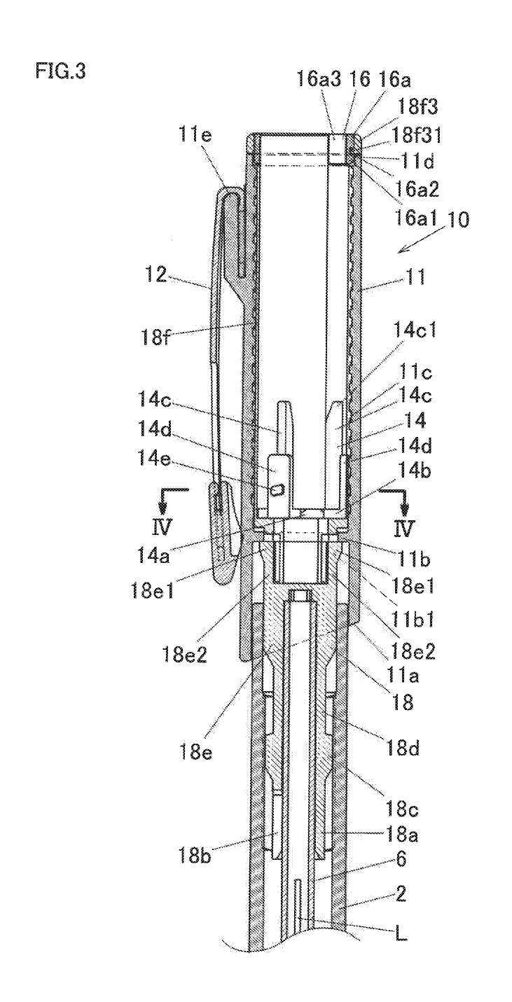

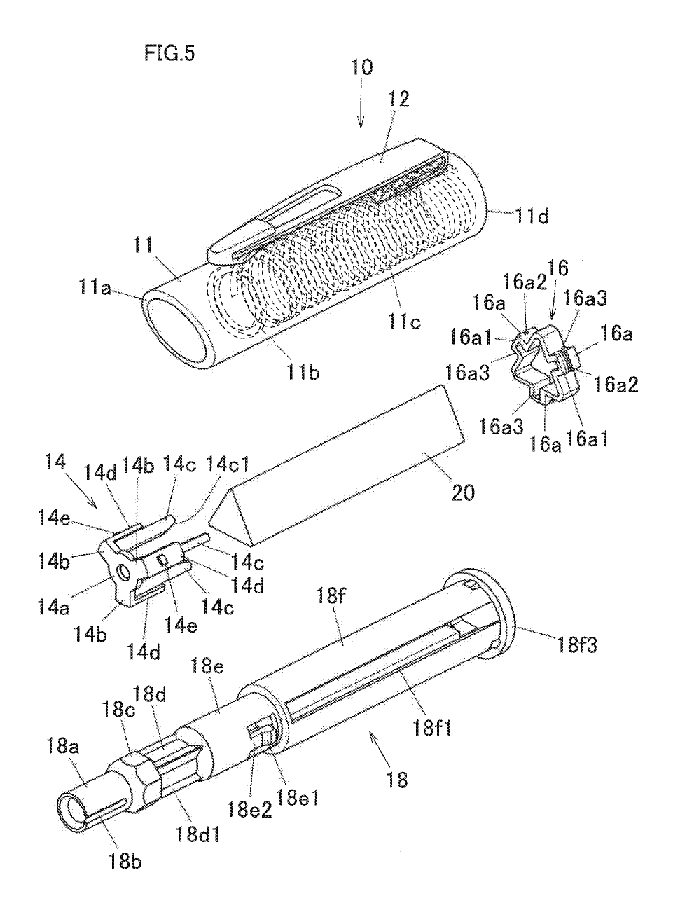

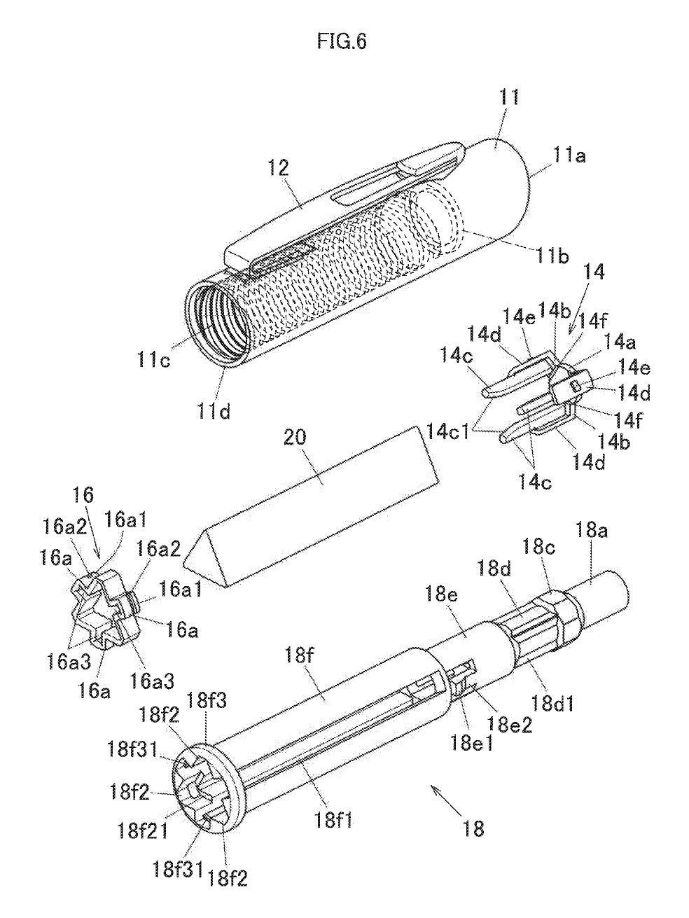

Next, the rod-like object dispensing container 10 will be further described in detail with reference to FIGS. 3 to 8. As illustrated in FIG. 3, the rod-like object dispensing container 10 includes the helical cylinder 11, a rod-like object holder 14, a covering 16, and the inner cylinder 18. As illustrated in FIGS. 5 and 6, an annular rib 11b is formed on an inner circumferential surface slightly to the rear of the front end opening part 11a of the helical cylinder 11. A helical groove 11c is formed on a rearward inner circumferential surface of the annular rib 11b. The helical groove 11c is formed to a vicinity of a rear end opening part 11d of the helical cylinder 11. In addition, as illustrated in FIG. 3, a clip base part 11e for supporting the clip 12 is formed in a rear end portion on an outer circumferential surface of the helical cylinder 11 and the clip 12 is mounted to the clip base part 11e.

The inner cylinder 18 formed in an approximately cylindrical shape is arranged inside the helical cylinder 11. A lead tank inserting part 18a with an approximately cylindrical shape is formed in a tip part of the inner cylinder 18. An insertion slit 18b extending in the axial direction from the tip part is formed in the lead tank inserting part 18a in order to make a lead tank more readily insertable. A rotation stopping part 18c with a larger diameter than the lead tank inserting part 18a is formed to the rear of the lead tank inserting part 18a of the inner cylinder 18. The rotation stopping part 18c is formed in an outer circumferential shape having a plurality of planes on an outer circumference around an axis thereof (a polygonal sectional shape). In the present embodiment, the rotation stopping part 18c is formed in an outer circumferential shape having eight planes (an octagonal sectional shape). A linking cylindrical part 18d with a smaller diameter than the rotation stopping part 18c (approximately the same outer diameter as the lead tank inserting part 18a) is formed to the rear of the rotation stopping part 18c of the inner cylinder 18. Four longitudinal ribs 18d1 extending in the axial direction are formed on an outer circumferential surface of the linking cylindrical part 18d.

A locking cylindrical part 18e with a diameter which is larger than the linking cylindrical part 18d and which is approximately the same as a maximum outer diameter of the rotation stopping part 18c is formed to the rear of the linking cylindrical part 18d of the inner cylinder 18. Locking cylindrical pawls 18e1 are arranged so as to oppose each other at two locations on an outer circumference of the locking cylindrical part 18e. The locking cylindrical pawl 18e1 is formed so as to have an inclined surface that faces forward on a forward side thereof and to protrude in an outer diameter direction in a rear end part of an elastic piece 18e2 that is formed on an outer circumference of the locking cylindrical part 18e by being cut out in an approximate U shape.

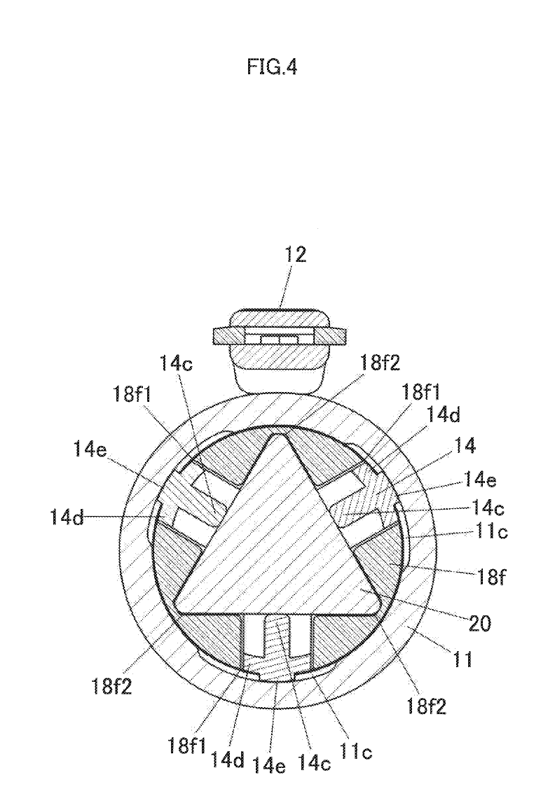

A guiding cylindrical part 18f with a larger diameter than the locking cylindrical part 18e is formed to the rear of the locking cylindrical part 18e of the inner cylinder 18. The guiding cylindrical part 18f is formed so as to be longer than a combined length in the axial direction of the lead tank inserting part 18a, the rotation stopping part 18c, the linking cylindrical part 18d, and the locking cylindrical part 18e, and three slits 18f1 extending in the axial direction are formed on an outer circumferential surface of the guiding cylindrical part 18f. As will be described in detail particularly with reference to FIG. 4, a vertex part guiding groove 18f2 extends in the axial direction so as to guide each vertex part of the rod-like object 20, the transverse section of which is a triangular shape. As illustrated in FIG. 4, when viewed from the rear, the slits 18f1 are respectively arranged at positions opposing the vertex part guiding grooves 18f2. In addition, as illustrated in FIGS. 3, 5, and 6, a flange part 18f3 is formed at a rear end of the guiding cylindrical part 18f. Furthermore, as illustrated in FIG. 6, a projection 18f31 that protrudes in a horizontal (transverse) plate shape in an inner diameter direction is formed in the flange part 18f3 corresponding to the rear of the slit 18f1 in a vicinity of a rear end opening part of the inner cylinder 18. A step part 18f21 is formed in the vertex part guiding groove 18f2 in the vicinity of the rear end opening part of the inner cylinder 18. The projection 18f31 is formed to the rear of the step part 18f21. The projection 18f31 restricts the assembled rod-like object holder 14 so that the rod-like object holder 14 does not slide further rearward from a rear end part of the slit 18f1 and slip out from the slit 18f1.

Next, the rod-like object holder 14 will be described. As will be described in detail later, the rod-like object holder 14 has a bottom plate and a plurality of sliding piece parts, the bottom plate includes a receiving part 14a and a sliding piece base part 14b, and each sliding piece part includes a rod-like object supporting part 14c, a sliding piece main body part 14d, and a protruding part 14e. As illustrated in FIGS. 5, 6, and 7, the receiving part 14a that receives an end surface of the rod-like object 20 is formed in an approximate disk shape in the rod-like object holder 14. The receiving part 14a constitutes the bottom plate of the rod-like object holder. Three sliding piece base parts 14b with an approximate plate shape and radially extending in an outer diameter direction are formed so as to originate from the receiving part 14a. A plate thickness of the receiving part 14a and a plate thickness of the sliding piece base parts 14b are formed approximately the same. The rod-like object supporting parts 14c are formed so as to respectively extend rearward in the axial direction from a rearward-side surface that is one surface of each sliding piece base part 14b. Due to the rod-like object supporting parts 14c, an outer-side surface of the rod-like object 20 is supported from an outer side toward an inner side in the radial direction. Tapered parts 14c1 for facilitating introduction of the rod-like object 20 are respectively formed at tip parts of the rod-like object supporting parts 14c so as to have an introducing inclined surface constituted so that an inner diameter of an opening increases toward the rear (in a direction of the tips of the rod-like object supporting parts 14c). Furthermore, the sliding piece main body parts 14d are respectively formed so as to extend in a same direction as the rod-like object supporting parts 14c (in other words, rearward) in the axial direction from each outer-side end part of the sliding piece base parts 14b on an outer side in the radial direction than the rod-like object supporting parts 14c. The sliding piece main body parts 14d are formed in a curved plate shape with a width that is approximately the same as the sliding piece base parts 14b. In addition, one protruding part 14e is respectively formed on a surface on the outer side in the radial direction of the sliding piece main body parts 14d. Each protruding part 14e slidably engages with the helical groove 11c of the helical cylinder 11. Therefore, each protruding part 14e is arranged at a different position in the circumferential direction.

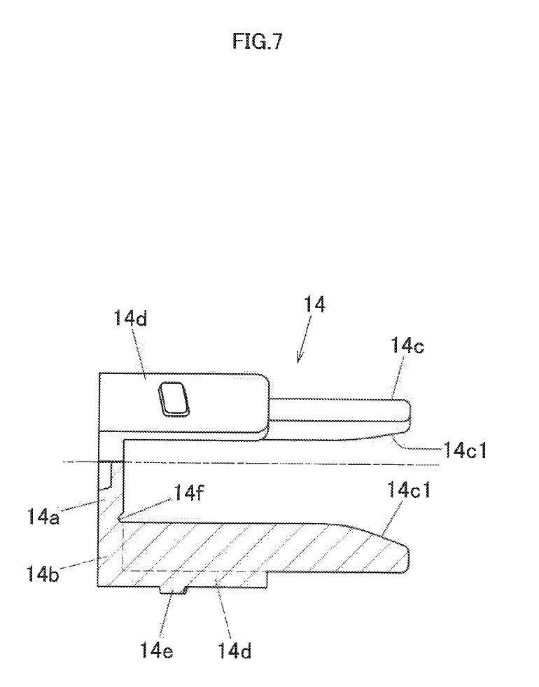

In a plurality of embodiments of the present invention, a thin wall part extending in a direction that intersects a radial direction thereof is formed in each supporting base part of each sliding piece part of the bottom plate that supports each sliding piece part of the rod-like object holder. In a plurality of embodiments of the present invention, the thin wall part extending in a direction that intersects the radial direction is preferably configured to guide each sliding piece part toward a central axis so as to bend the sliding piece part and, while the thin wall part is formed so as to extend in a direction perpendicular to the radial direction in the present embodiment, for example, a thin wall part extending in the circumferential direction may be formed in other embodiments. In a plurality of embodiments of the present invention, the rod-like object holder is configured so as to have prescribed elasticity. The rod-like object holder 14 according to the present embodiment is formed using a resin material. In the present embodiment, as illustrated in FIGS. 6 and 7, a groove part 14f with a recessed groove shape and extending in a direction perpendicular to the radial direction is formed in an outer circumferential portion of each receiving part 14a that supports each sliding piece base part 14b in a cantilevered manner on a side of one surface (in other words, a rear surface side) that is a receiving surface side of the receiving part 14a. A portion of the receiving part 14a of the rod-like object holder 14 in which the groove part 14f is formed constitutes a thin wall part, the thickness of which in the axial direction is reduced as compared to thickness of the other receiving parts 14a and the sliding piece base parts 14b. The outer circumferential portion of the receiving part 14a of the bottom plate according to the present embodiment is a supporting base part that supports each sliding piece part. By adopting such a configuration, since the bottom plate of the rod-like object holder bends more readily at the thin wall part, each sliding piece part can be configured so as to bend in a preferable manner toward a central axis when the sliding piece part is pressed in an inner diameter direction. Therefore, as will be described in detail later, the rod-like object holder can be readily assembled to the inner cylinder.

As illustrated in FIGS. 3 and 4, each sliding piece main body part 14d of the rod-like object holder 14 slidably engages with the slit 18f1 of the inner cylinder 18. In addition, the three rod-like object supporting parts 14c support the rod-like object 20 in a direction from the outer diameter direction toward the inner diameter direction. A rear end surface of the rod-like object 20 abuts with one of the surfaces of the receiving part 14a.

As illustrated in FIG. 3, the covering 16 is assembled to the rear end opening part of the inner cylinder 18. In a plurality of embodiments of the present invention, the covering is configured so as to have prescribed elasticity. The covering 16 according to the present embodiment is formed using a resin material. As illustrated in FIGS. 5 and 6, the covering 16 is formed in an approximately triangular shape so as to enclose the outer circumference of the rod-like object 20, a transverse section of which is a triangular shape. In addition, a locking pawl part 16a that protrudes outward is formed at an approximately central position of each side of the covering 16. By adopting such a configuration, the locking pawl part 16a is elastically supported in an outer diameter direction by each side of the approximately triangular shape. Therefore, as will be described in detail later, the covering 16 can be readily assembled to the rear end opening part of the inner cylinder 18 with the locking pawl part 16a. A tapered part 16a1 having an insertion inclined surface configured so that an outer diameter decreases toward the front is formed on a forward side on an outer circumferential side surface of the locking pawl part 16a in order to enable the covering 16 to be more readily assembled to the inner cylinder 18. A locking groove 16a2 extending along the circumferential direction is formed to the rear of the tapered part 16a1. In addition, a through groove 16a3 penetrating and extending in a front-rear direction is formed on an inner circumferential side surface of the locking pawl part 16a.

In order to assemble the rod-like object holder 14 and the covering 16 to the inner cylinder 18, first, the rod-like object holder 14 is inserted from a side of the receiving part 14a toward the front to the rear end opening part of the inner cylinder 18 in a state where positions in the circumferential direction of the sliding piece main body part 14d and the slit 18f1 of the inner cylinder 18 are aligned. At this point, the three rod-like object supporting parts 14c are pinched to tilt the sliding piece base parts 14b, the rod-like object supporting parts 14c, and the sliding piece main body parts 14d inward in the radial direction. As a result, since the protruding parts 14e also move inward in the radial direction, the rod-like object holder 14 can be inserted and assembled to the inner cylinder 18 while avoiding interference between the sliding piece main body parts 14d and the protruding parts 14e, and the projection 18f31 of the inner cylinder 18. The rod-like object holder 14 is arranged so that, when the rod-like object 20 is assembled to the rod-like object holder 14, a center of a front end part of the rod-like object 20 is approximately positioned above the central axis of the mechanical pencil 1 by supporting the front end part of the rod-like object 20.

On the other hand, a rear end part of the rod-like object 20 is arranged so that, by being supported by the covering 16 assembled to the inner cylinder 18, a center of the rear end part of the rod-like object 20 is approximately positioned above the central axis of the mechanical pencil 1. The assembly of the covering 16 to the inner cylinder 18 can be readily performed by inserting the covering 16 into the rear end opening part of the inner cylinder 18 in a state where the tapered part 16al of the locking pawl part 16a of the covering 16 is directed forward and positions of the locking pawl part 16a and the vertex part guiding groove 18f2 of the inner cylinder 18 are aligned in the circumferential direction. At this point, as the tapered part 16al of the locking pawl part 16a is pressed inward in the radial direction by the projection 18f31 of the inner cylinder 18 and the covering 16 elastically deforms, the locking pawl part 16a moves inward in the radial direction. Subsequently, as the locking pawl part 16a is restored outward in the radial direction, the projection 18f31 of the inner cylinder 18 fits into the locking groove 16a2 of the covering 16. A front surface part of a portion corresponding to a vertex of the covering 16 abuts with the step part 18f21 of the inner cylinder 18. In this manner, the covering 16 is locked to the inner cylinder 18.

Next, the assembly of the inner cylinder 18 to the helical cylinder 11 will be described. The inner cylinder 18 into which are assembled the rod-like object holder 14 and the covering 16 is inserted into the rear end opening of the helical cylinder 11 from the side of the lead tank inserting part 18a in a state where the protruding part 14e of the rod-like object holder 14 and the helical groove 11c of the helical cylinder 11 are aligned and engaged with each other. Specifically, by inserting the inner cylinder 18 while rotating the inner cylinder 18 with respect to the helical cylinder 11, the protruding part 14e of the rod-like object holder 14 and the helical groove 11c can be aligned and assembled.

Once the inner cylinder 18 is inserted into the helical cylinder 11, the locking cylindrical pawl 18e1 of the inner cylinder 18 having prescribed elasticity in the radial direction is pressed in an inner radial direction by the annular rib 11b of the helical cylinder 11, and the locking cylindrical pawl 18e1 elastically deforms and becomes embedded inward in the radial direction of the locking cylindrical part 18e in a state where an inclined surface on a front side of the locking cylindrical pawl 18e1 and the annular rib 11b slide against each other. In addition, when the inner cylinder 18 is inserted into the helical cylinder 11, the shape of the locking cylindrical pawl 18e1 is elastically restored after the locking cylindrical pawl 18e1 climbs over the annular rib 11b and a front surface of the annular rib 11b becomes positioned so as to oppose a rear surface of the locking cylindrical pawl 18e1. At this point, the rear surface of the locking cylindrical pawl 18e1 and the front surface of the annular rib 11b abut with or are close to each other. In this state, the annular rib 11b is to be positioned between the rear surface of the locking cylindrical pawl 18e1 of the inner cylinder 18 and a front end surface of the guiding cylindrical part 18f of the inner cylinder 18 which has a larger diameter than the locking cylindrical part 18e. Accordingly, the inner cylinder 18 is assembled to the helical cylinder 11 in a state where the inner cylinder 18 is rotatable around the axis but restricted from moving in the axial direction.

With the rod-like object dispensing container 10 assembled as described above, furthermore, as illustrated in FIG. 3, the lead tank 6 of the mechanical pencil 1 is inserted into the lead tank inserting part 18a of the inner cylinder 18 and, at the same time, up to a portion of the locking cylindrical part 18e is inserted into the front barrel 2 of the mechanical pencil 1 and assembled to the front barrel 2 of the mechanical pencil 1. At this point, due to an engagement of the rotation stopping part 18c of the lead tank inserting part 18a and an inner circumferential surface of the front barrel 2, the inner cylinder 18 is fixed to the front barrel 2. In this state, by relatively rotating the helical cylinder 11 with respect to the front barrel 2, since the protruding part 14e is propelled by the helical groove 11c, the rod-like object holder 14 moves in the front-rear direction in the axial direction while relatively rotating around the axis with respect to the helical cylinder 11. In this manner, the rod-like object 20 can be dispensed from and housed (retracted) into the rod-like object dispensing container 10.

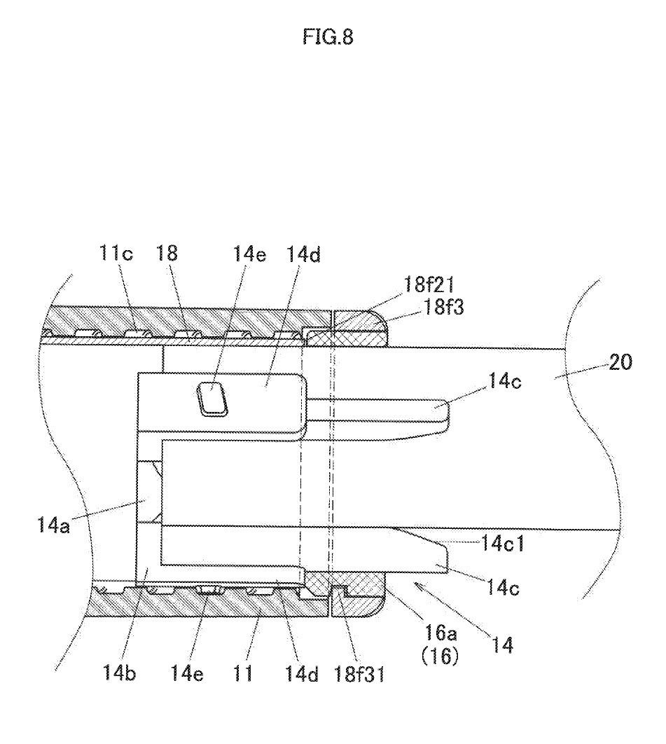

In this case, when the helical cylinder 11 is continuously relatively rotated in a direction of dispensing the rod-like object 20 with respect to the front barrel 2 (the inner cylinder 18), as illustrated in FIG. 8, a state is created where a rear end surface of the sliding piece main body part 14d abuts with a front end surface of the locking pawl part 16a of the covering 16. In this state, the rod-like object holder 14 is restricted from further moving in the dispensing direction (in other words, rearward). At this point, the rod-like object supporting part 14c penetrates through the through groove 16a3 of the locking pawl part 16a of the covering 16 and protrudes more rearward than the rear end opening part of the inner cylinder 18.

As with conventional structures, when a movement restricting part for restricting a rearward movement of a rod-like object holder that protrudes inward in the radial direction is directly provided in a rear end opening part of an inner cylinder, inserting the rod-like object holder into the inner cylinder during assembly requires that a sliding piece main body part be tilted by a significant degree in order to avoid interference between the sliding piece main body part and the movement restricting part of the rear end opening part of the inner cylinder. In contrast, in the present embodiment, due to the locking pawl part 16a of the covering 16 configured separately from the inner cylinder 18, a rearward movement of the rod-like object holder 14 can be restricted after the rod-like object holder 14 is assembled. Therefore, in the present embodiment, the tilt of the sliding piece main body part 14d described above when inserting the rod-like object holder 14 into the inner cylinder 18 can be made smaller than what is conventional. As a result, assembly work of the rod-like object holder 14 becomes easier than before. In addition, since the sliding piece main body part 14d accurately tilts toward a central axis by elastically deforming so as to bend at the groove part 14f that is a thin wall part, the sliding piece main body part 14d is prevented from tilting in a direction that deviates away from an opening direction of the slit 18f1 of the inner cylinder 18.

Furthermore, when a sliding piece part tilts so as to bend at the groove part 14f that is formed as a thin wall part as in the present embodiment, the rod-like object holder 14 can be made to elastically deform and the sliding piece part can be tilted by a smaller force as compared to conventional structures. In the present embodiment, since the groove part 14f is formed on an inner side of bending of the rod-like object holder 14 to constitute a thin wall part, an outer side of bending to be subjected to a tensile load can be formed as a continuous surface. Therefore, the rod-like object holder 14 can be formed as a component with higher strength. In addition, when inserting the rod-like object holder 14 into the inner cylinder 18, since the rod-like object holder 14 can be uniformly bent at a position of a thin wall part (the groove part 14f) and a plurality of sliding piece parts can be uniformly tilted, assembly work can be performed more readily than before.

In the mechanical pencil 1 according to the present embodiment, when the rod-like object holder 14 is dispensed to a maximum dispensing position, since the rod-like object 20 can be dispensed to a position where a tip portion of the rod-like object supporting part 14c protrudes from the rear end opening part of the inner cylinder 18, a shorter rod-like object 20 as compared to conventional structures can be readily replaced. In this case, since the tapered part 14c1 is formed in a tip portion of the rod-like object supporting part 14c, the rod-like object 20 can be replaced even more easily.

While an embodiment of the present invention has been described above, it is to be understood that the present invention is not limited to the embodiment described above and can be implemented with a wide variety of modifications. For example, the groove part 14f provided on the rod-like object holder 14 is not limited to the groove part 14f described earlier and a thin wall part may be formed by creating the groove part 14f in a step shape, tilting the groove part 14f so as to have a prescribed tilt angle with respect to the radial direction, or the like. In addition, as described earlier, the rod-like object 20 is not limited to an eraser and various rod-like objects including any stationery, any cosmetic product, and the like may be used. Furthermore, the rod-like object dispensing container 10 may be mounted to a ball pen or another article, or may be formed independently.

What is claimed is:

1. A rod-like object dispensing container, including:
a helical cylinder configured to have a helical groove on a cylindrical inner circumferential surface;
an inner cylinder configured to be formed in a cylindrical shape and arranged inside the helical cylinder, and configured to have a plurality of slits extending in an axial direction, and configured to be relatively rotatable with respect to the helical cylinder around an axis and configured so that movement in the axial direction is restricted; and
a rod-like object holder configured to hold a rod-like object, and configured to be relatively movable in the axial direction with respect to the inner cylinder, wherein
the rod-like object holder includes
a bottom plate configured to have a receiving part receiving an end surface of the rod-like object, a plurality of sliding piece parts configured to have a rod-like object supporting part extending in the axial direction and supporting an outer surface of the rod-like object, and configured to slidably engage with the slits of the inner cylinder, and a plurality of protruding parts configured to protrude outward in a radial direction from the sliding piece parts respectively and configured to slidably engages with the helical groove of the helical cylinder, and
a thin wall part configured to extend in a direction intersecting the radial direction is formed in each supporting base part for the sliding piece parts of the bottom plate supporting the sliding piece parts.

2. The rod-like object dispensing container according to claim 1, wherein the thin wall part of the rod-like object holder is constituted by forming a recessed groove in the bottom plate.

3. The rod-like object dispensing container according to claim 1, wherein on each of the tip parts of the rod-like object supporting parts of the rod-like object holder, a tapered part is formed so as to have an introducing inclined surface configured to be an inner diameter of an opening of the rod-like object holder increasing toward the tips of the rod-like object supporting parts.

4. The rod-like object dispensing container according to claim 2, wherein on each of the tip parts of the rod-like object supporting parts of the rod-like object holder, a tapered part is formed so as to have an introducing inclined surface configured to be an inner diameter of an opening of the rod-like object holder increasing toward the tips of the rod-like object supporting parts.

5. The rod-like object dispensing container according to claim 1, further comprising a covering configured to be mounted on a rear end part of the inner cylinder and configured to restrict movement of the rod-like object holder in the axial direction.

6. The rod-like object dispensing container according to claim 2, further comprising a covering configured to be mounted on a rear end part of the inner cylinder and configured to restrict movement of the rod-like object holder in the axial direction.

7. The rod-like object dispensing container according to claim 3, further comprising a covering configured to be mounted on a rear end part of the inner cylinder and configured to restrict movement of the rod-like object holder in the axial direction.

8. The rod-like object dispensing container according to claim 4, further comprising a covering configured to be mounted on a rear end part of the inner cylinder and configured to restrict movement of the rod-like object holder in the axial direction.

9. The rod-like object dispensing container according to claim 5, wherein the covering configured to abut with the sliding piece parts of the rod-like object holder to restrict movement of the rod-like object holder in the axial direction.

10. The rod-like object dispensing container according to claim 6, wherein the covering configured to abut with the sliding piece parts of the rod-like object holder to restrict movement of the rod-like object holder in the axial direction.

11. The rod-like object dispensing container according to claim 7, wherein the covering configured to abut with the sliding piece parts of the rod-like object holder to restrict movement of the rod-like object holder in the axial direction.

12. The rod-like object dispensing container according to claim 8, wherein the covering configured to abut with the sliding piece parts of the rod-like object holder to restricts movement of the rod-like object holder in the axial direction.

13. The rod-like object dispensing container according to claim 5, wherein a locking pawl configured to be elastically supported in an outer diameter direction is formed on the covering, and the covering is assembled to the inner cylinder by being locked in a state where the locking pawl of the covering is elastically supported, in the outer diameter direction, with respect to an inner circumferential surface of the inner cylinder from an inner side of the inner cylinder.

14. The rod-like object dispensing container according to claim 6, wherein a locking pawl configured to be elastically supported in an outer diameter direction is formed on the covering, and the covering is assembled to the inner cylinder by being locked in a state where the locking pawl of the covering is elastically supported, in the outer diameter direction, with respect to an inner circumferential surface of the inner cylinder from an inner side of the inner cylinder.

15. The rod-like object dispensing container according to claim 7, wherein a locking pawl configured to be elastically supported in an outer diameter direction is formed on the covering, and the covering is assembled to the inner cylinder by being locked in a state where the locking pawl of the covering is elastically supported, in the outer diameter direction, with respect to an inner circumferential surface of the inner cylinder from an inner side of the inner cylinder.

16. The rod-like object dispensing container according to claim 9, wherein a locking pawl configured to be elastically supported in an outer diameter direction is formed on the covering, and the covering is assembled to the inner cylinder by being locked in a state where the locking pawl of the covering is elastically supported, in the outer diameter direction, with respect to an inner circumferential surface of the inner cylinder from an inner side of the inner cylinder.

17. The rod-like object dispensing container according to claim 5, wherein the rod-like object supporting parts of the rod-like object holder are configured to protrude further in the axial direction than the sliding piece parts of the rod-like object holder, and the covering is configured to have a through groove formed so as to be penetrable by each of the rod-like object supporting parts.

18. The rod-like object dispensing container according to claim 9, wherein the rod-like object supporting parts of the rod-like object holder are configured to protrude further in the axial direction than the sliding piece parts of the rod-like object holder, and the covering is configured to have a through groove formed so as to be penetrable by each of the rod-like object supporting parts.

19. The rod-like object dispensing container according to claim 13, wherein the rod-like object supporting parts of the rod-like object holder are configured to protrude further in the axial direction than the sliding piece parts of the rod-like object holder, and the covering is configured to have a through groove formed so as to be penetrable by each of the rod-like object supporting parts.

20. The rod-like object dispensing container according to claim 1, wherein the transverse section of the rod-like object is formed in a triangular shape, and the rod-like object supporting parts of three of the rod-like object holders are formed to support each side portion of the triangular shape of the transverse section of the rod-like object.
